(19) United States
(12) Patent Application Publication
(10) Pub. No.: US 2025/0232127 A1
(43) Pub. Date: Jul. 17, 2025

(54) INFORMATION PROCESSING SYSTEM

(71) Applicant: Semiconductor Energy Laboratory Co., Ltd., Atsugi-shi (JP)

(72) Inventors: Kengo AKIMOTO, Isehara (JP); Junpei MOMO, Sagamihara (JP)

(21) Appl. No.: 19/008,710

(22) Filed: Jan. 3, 2025

(30) Foreign Application Priority Data
Jan. 12, 2024 (JP) 2024-003235

(51) Int. Cl. G06F 40/35

(52) U.S. Cl. CPC G06F 40/35

(57) ABSTRACT

An information processing system that assisting a user's discussion is provided. The information processing system includes an input/output interface that obtains voice data of a user and displays information related to the voice data of the user, a processing unit that creates text data based on the voice data and creates a prompt including the text data, and an information collecting unit that collects information based on the prompt and generates an information table and a question to the user. The input/output interface has a function of outputting the voice data to the processing unit. The processing unit has a function of transmitting the prompt to the information collecting unit. The information collecting unit has a function of transmitting the information table and the question to the user to the processing unit. The processing unit has a function of creating information related to the voice data of the user based on the information table and the question to the user and outputting the information to the input/output interface.

### BACKGROUND OF THE INVENTION

### 1. Field of the Invention

One embodiment of the present invention relates to an information processing system and an information processing method.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Specific examples of the technical field of one embodiment of the present invention disclosed in this specification include a semiconductor device, a display device, a light-emitting device, a power storage device, a memory device, a method for driving any of them, and a method for manufacturing any of them.

### 2. Description of the Related Art

In recent years, language models using neural networks have been actively developed, and especially large language models (LLM) have attracted attention. A large language model is a natural language processing model in which learning is performed using a massive amount of data. With a large language model, for example, a conversational model that gives an answer to a user's instruction can be achieved. In Non-Patent Document 1, generative pre-trained transformer 4 (GPT-4, registered trademark) is disclosed as a large language model, and ChatGPT is disclosed as a conversational model.

### REFERENCE

### Non-Patent Document

Non-Patent Document 1 Summary of ChatGPT/GPT-4 Research and Perspective Towards the Future of Large Language Models, Yiheng Liu et al., (submitted on 4 Apr. 2023) [online], Internet URL: https://arxiv.org/abs/2304.01852

### SUMMARY OF THE INVENTION

A large language model can be used to summarize the record of conversation or the minutes and extract key points. For example, when a trouble occurs in a company, a draft of a report on the trouble (hereinafter referred to as a trouble report) can be created on the basis of the record of conversation on the trouble.

In the case where a large language model is used to extract key points from the record of conversation or the like after the discussion, the user needs to check the key points and make a discussion again or modify the key points when concluding that the discussion content has been insufficient. Thus, the use of the large language model is not advantageous to the user. For example, when a trouble report is created using the large language model on the basis of an insufficient discussion content, making a complete trouble report is too difficult to prevent recurrence of the trouble. In addition, a fishbone diagram or the like, which is necessary to derive a proposed solution, needs to be created from the trouble report, but is difficult to create only with the large language model.

Thus, one embodiment of the present invention provides an information processing system that monitors a user's discussion in real time and displays an information table and a question to the user on the basis of the discussion content, thereby assisting the user's discussion. Another embodiment of the present invention provides the information processing system with the above structure, which displays the information table converted into a format that is easily read by the user (e.g., a fishbone diagram).

One embodiment of the present invention is an information processing system including an input/output interface that obtains voice data of a user and displays information related to the voice data of the user, a processing unit that creates text data based on the voice data of the user and creates a prompt including the text data, and an information collecting unit that collects information based on the prompt and generates an information table and a question to the user. The input/output interface has a function of outputting the voice data to the processing unit. The processing unit has a function of transmitting the prompt to the information collecting unit. The information collecting unit has a function of transmitting the information table and the question to the user to the processing unit. The processing unit has a function of creating information related to the voice data of the user based on the information table and the question to the user and outputting the information to the input/output interface.

In the information processing system with the above structure, the processing unit has a function of converting a display format of the information table, and the information related to the voice data of the user includes, for example, at least any one of the information table, the question to the user, and the information table with the converted display format.

In the information processing system with the above structure, the information collecting unit is capable of collecting information about a trouble, for example.

In the information processing system with the above structure, the processing unit has a function of converting the information table into a fishbone diagram, and the information related to the voice data of the user includes, for example, at least any one of the information table, the question to the user, and the fishbone diagram.

According to one embodiment of the present invention, an information processing system that assists a user's discussion can be provided. According to another embodiment of the present invention, an information processing system that assists in creating a trouble report can be provided. According to another embodiment of the present invention, an information processing system that creates a fishbone diagram can be provided.

### BRIEF DESCRIPTION OF THE DRAWINGS

In the accompanying drawings:

FIG. 1 shows an example of a block diagram of an information processing system of one embodiment of the present invention;

FIG. 2 shows a flowchart of information processing of one embodiment of the present information;

FIG. 3 shows an example of a text created by an information processing system of one embodiment of the present information;

FIG. 4 shows a flowchart of information processing of one embodiment of the present information;

FIG. 5 shows a flowchart of information processing of one embodiment of the present information; and

FIG. 6 shows an example of a network configuration diagram of an information processing system of one embodiment of the present invention.

### DETAILED DESCRIPTION OF THE INVENTION

Hereinafter, an embodiment of the present invention will be described in detail with reference to the drawings. Note that the present invention is not limited to the description below, and it is easily understood by those skilled in the art that modes and details of the present invention can be modified in various ways. In addition, the present invention should not be construed as being limited to the description in the following embodiment.

### Embodiment

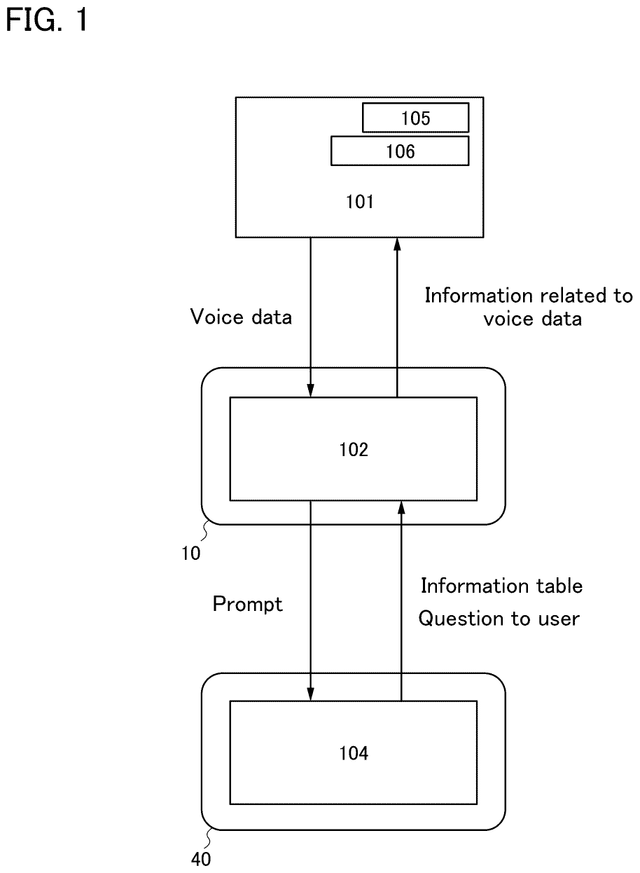

In this embodiment, an information processing system of one embodiment of the present invention is described with reference to FIG. 1 to FIG. 6.

FIG. 1 shows an example of an information processing system of one embodiment of the present invention. The information processing system of one embodiment of the present invention includes at least an input/output interface 101, a processing unit 102, and an information collecting unit 104. In the information processing system of one embodiment of the present invention, voice data of a user is obtained in the input/output interface 101, text data based on the voice data of the user and a prompt including the text data are created in the processing unit 102 included in an information processing device 10, the prompt is transmitted via a network to the information collecting unit 104 included in an information processing device 40, and processing using a language model is performed in the information collecting unit 104.

Although not illustrated, the information processing system of one embodiment of the present invention may have a configuration in which one information processing device includes at least part of the processing unit 102 and at least part of the information collecting unit 104. The information processing system of one embodiment of the present invention may also have a configuration in which one information processing device includes at least part of the input/output interface 101 and at least part of the processing unit 102. The information processing system of one embodiment of the present invention may also have a configuration in which one information processing device includes at least part of the input/output interface 101, at least part of the processing unit 102, and at least part of the information collecting unit 104.

### Input/Output Interface

The input/output interface 101 is capable of obtaining user's voice and displaying information related to voice data of the user. Thus, the input/output interface 101 includes at least a voice input unit 106, which is capable of recording the user's voice, and a display unit 105, which is capable of displaying information. Specific examples of the user's voice include voice data recorded during a user's discussion. Specific examples of the information related to the voice data of the user include an information table, a question to the user, and an information table converted into a format that is easily read by the user. Note that in this specification, the user's discussion means that one user or several users express opinions.

The input/output interface 101 is an information processing device including the voice input unit 106 and the display unit 105. The input/output interface 101 is, for example, a portable information terminal typified by a smartphone or a tablet computer or an information processing device typified by a desktop computer including a keyboard or a laptop computer. The voice input unit 106 is, for example, a microphone. The display unit 105 is, for example, a display device such as a liquid crystal display device or an organic EL display device.

### Processing Unit

The processing unit 102 has a function of receiving voice data from the input/output interface 101 and creating text data based on the voice data, i.e., transcribing the user's discussion.

The processing unit 102 also has a function of adding an instruction sentence to the created text data to create a prompt and transmitting the created prompt to the information collecting unit 104 via a network. The instruction sentence includes instructions to collect information from the text data and generate an information table and a question to the user about information missing from the information table.

Examples of the information table capable of being generated by the processing unit 102 include a status check table regarding the trouble and a tree diagram regarding the trouble. The following are specific examples of the instruction sentence including instructions to generate an information table and a question to the user.

### Instruction Sentence Example 1

“I am currently in the process of reporting the trouble. From the discussion content, summarize “when”, “where”, “who”, “how”, and “what happened” in a status check table, and then create a question about the information that is missed from the status check table ”.

### Instruction Sentence Example 2

“I am currently in the process of analyzing the factor of the trouble and discussing countermeasures. Summarize the statements in the discussion and create a tree diagram. The tree diagram is used in the following cases: a large concept is developed while gradually branched out into smaller concepts to propose measures to solve problems (strategy development type), and constituent elements of a thing are organized to check the mutual relationship between elements or check missing elements (constituent element development type). In the tree diagram, provide the four factors, a human factor, a system factor, a method factor, and a material factor in the lower level of each of an occurrence factor and improvement measures, and classify the statements into the factors. Then, create questions about a factor with no statement among the human, system, method, and material factors with respect to each of the occurrence factor and the improvement measures”.

When an instruction sentence such as Instruction sentence example 1 or Instruction sentence example 2 is added to a prompt, information on the trouble can be collected by the information collecting unit 104, which can give aid to the user's discussion and assist the user in creating a trouble report.

In the prompt, an information table to be created and an output format of a question to the user can be specified. Specific examples of the format, which is not particularly limited, include HTML and JavaScript Object Notation (abbreviation: json).

The processing unit 102 is capable of determining an instruction sentence included in the prompt in accordance with the progress of the user's discussion. The progress of the discussion is determined by the processing unit 102 on the basis of the information table created by the information collecting unit 104. For example, in the initial stage of the discussion, a prompt based on Instruction sentence example 1 is created. Then, a prompt based on Instruction sentence example 2 can be created when it is determined that the information table is filled with the information necessary in the initial stage of the discussion, i.e., “when”, “where”, “who”, “how”, and “what happened”.

The processing unit 102 receives the information table and the question to the user and determines whether the information table is filled with necessary information. Whether the information table is filled with necessary information can be determined by, for example, the fact that the information table contains no blank. For another example, it can be determined by whether the information collecting unit 104 generates a question to the user.

The processing unit 102 has a function of receiving the information table and the question to the user and outputting them to the input/output interface 101 as information related to the voice data of the user.

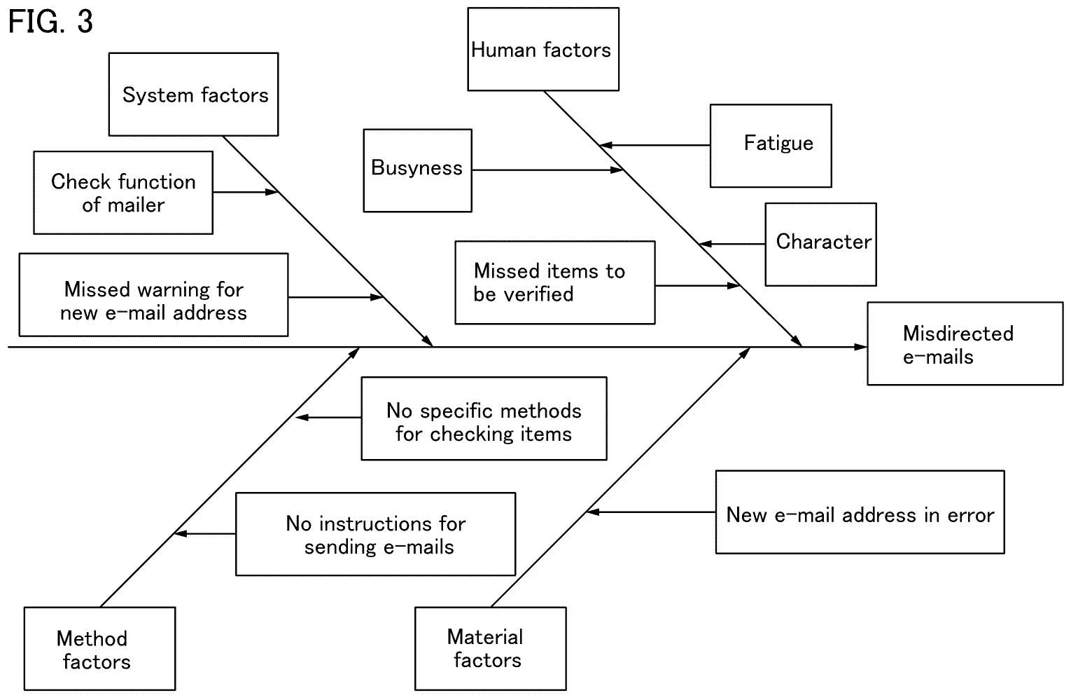

The processing unit 102 has a function of receiving the information table and the question to the user, converting the information table into a format that is easily read by the user, and outputting the converted information table to the input/output interface 101 as information related to the voice data of the user. For example, the processing unit 102 is capable of converting a status check table, which is generated by the information collecting unit 104 on the basis of a prompt created with Instruction sentence example 1 and includes “when”, “where”, “who”, “how”, and “what happened”, into a format that is easily read by the user. For another example, the processing unit 102 is capable of creating a fishbone diagram from an information table, which is generated by the information collecting unit 104 on the basis of a prompt created with Instruction sentence example 2 and includes major, medium, and minor factors that have caused the trouble. FIG. 3 shows an example of the fishbone diagram that can be created by the processing unit 102. The fishbone diagram in FIG. 3 is created on the basis of the aforementioned information table and the tree diagram of occurrence factors shown in Instruction sentence example 2.

The fishbone diagram can be created by the processing unit 102 in the following manner, for example: necessary information is extracted from the information table and input to commercially available software such as JUSE-StatWorks after being processed into an input format compatible with the software, and then output is obtained.

### Information Collecting Unit

When receiving a prompt from the processing unit 102, the information collecting unit 104 collects information based on the prompt and creates an information table and a question to the user about information missed from the information table. The information collecting unit 104 performs processing using a language model. The information collecting unit 104 is a large computer such as a server computer or a supercomputer. Specific examples of the information table and the question to the user are as follows. Note that Specific example 1 of information table and question to user is an example of the information table and the question that the information collecting unit 104 is capable of creating when receiving a prompt including Instruction sentence example 1 and text data created on the basis of the discussion on “trouble with a sputtering apparatus in a manufacturing process of a semiconductor device”. Specific example 2 of information table and question to user is an example of the information table and the question that the information collecting unit 104 is capable of creating when receiving a prompt including Instruction sentence example 2 and text data created on the basis of the discussion on “trouble with misdirected e-mails”.

### Specific Example 1 of Information Table and Question to User

When: No specific date and time shown
Where: A dry pump on the back of a sputtering apparatus
Who: Mr. A, a person in charge of apparatus, manager
How: In the state where the cleaning process is completed
What happened: A strange noise made from the dry pump and part of a joint found to be about to come undone
Question 1: Can you tell us specific date and time this trouble occurred?
Question 2: When this trouble occurred, Mr. A was conducting the operation alone or with other workers?

### Specific Example 2 of Information Table and Question to User

1. Occurrence factors
1.1 Human factors
1.1.1 Fatigue
1.1.2 Busyness
1.1.3 Missed items to be verified (bothersome and no time to verify)
1.1.4 Character (rough)
1.2 System factors
1.2.1 Check function of mailer (not verified though shown)
1.2.2 Missed warning for new e-mail address
1.3 Method factors
1.3.1 No instructions for sending e-mails
1.3.2 No specific methods for checking items to be verified
1.4 Material factors
1.4.1 New e-mail address in error
2. Improvement measures
2.1 Human factors
2.1.1 Environmental improvement to reduce fatigue and busyness
2.1.2 Raising awareness to avoid missing items to be verified
2.2 System factors
2.2.1 Improvement of check function of mailer (firm warning for new e-mail address)
2.3 Method factors
2.3.1 Making of instructions for sending e-mails
2.3.2 Specific method for checking items to be verified
2.4 Material factors
2.4.1 Enhanced verification of new e-mail address
   Question 1: Do you know a method for improving the rough character in the human factors?
   Question 2: Do you know a method for correcting a new e-mail address in error?

As shown in Specific examples 1 and 2 of information tables and questions to user, the information collecting unit 104 is capable of collecting information necessary for creating a trouble report and generating information tables and questions to the user, thereby giving aid to the user's discussion and assisting the user in creating a trouble report.

In the case where the user's discussion content is sufficient and no missing information is found in the information table, the information collecting unit 104 does not need to generate questions to the user.

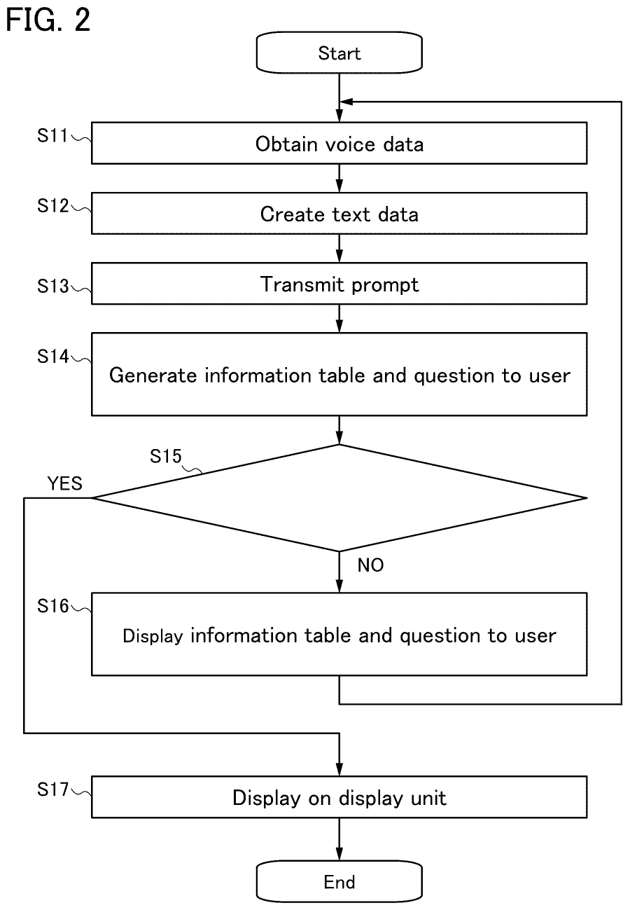

FIG. 2 shows an example of a processing flowchart of the information processing system of one embodiment of the present invention.

Processing flowchart 1

First, an input/output interface obtains voice data of a user (Step S11).

Then, a processing unit creates text data based on the recorded voice data (Step $12).

Next, the processing unit creates a prompt including the text data and an instruction sentence and transmits the prompt to an information collecting unit (Step S13).

The information collecting unit generates an information table and a question to the user on the basis of the received prompt (Step S14) and transmits them to the processing unit.

In the case where the user's discussion content is sufficient and no missing information is found in the information table, the information collecting unit does not generate a question in some cases.

On the basis of the information table and the question to the user received from the information collecting unit, the processing unit determines whether the information table is filled with necessary information (Step S15). The processing unit is capable of determining that the information table is filled with necessary information when the information table contains no blank or the question to the user is not generated.

When determining that the information table is not filled with necessary information in Step S15, the processing unit displays the information table and the question to the user on a display unit as information related to the voice data of the user (Step S16), and then the procedure returns to Step S11.

When determining that the information table is filled with necessary information in Step S15, the processing unit converts the information table into a display format that is easily read by the user and then displays the information table on the display unit as information related to the voice data of the user (Step S17). For example, an information table showing a tree diagram of occurrence factors is converted into a format of a fishbone diagram as shown in FIG. 3, and then can be displayed as information related to the voice data of the user.

Through the above processing flowchart, the information processing system of one embodiment of the present invention can give aid to the user's discussion and assist the user in creating a trouble report. In addition, a fishbone diagram can be created on the basis of the discussion content.

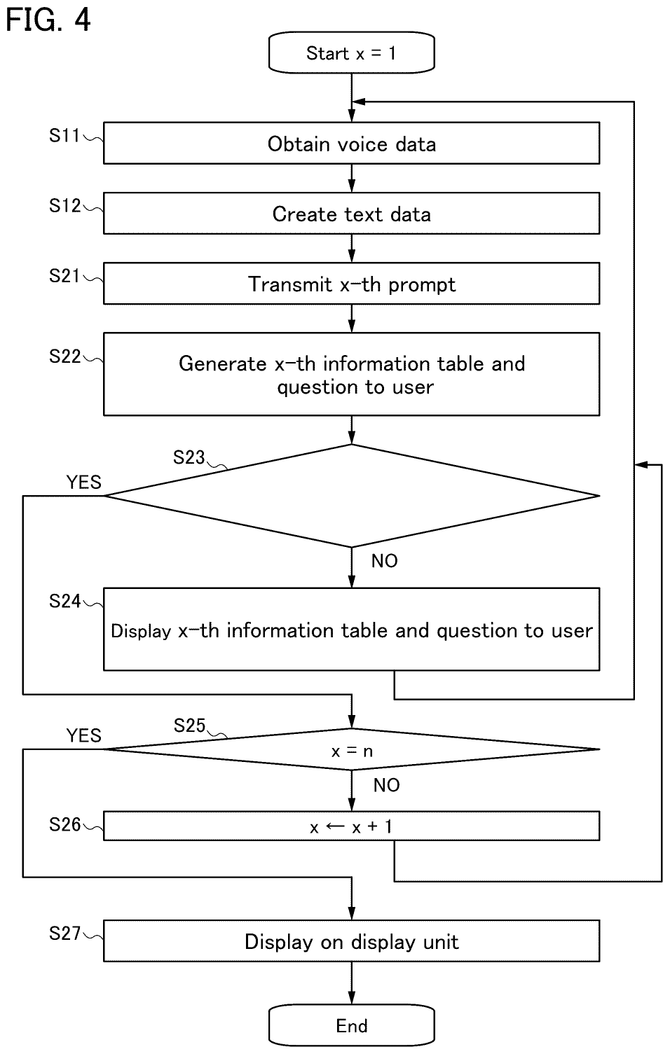

FIG. 4 shows another example of the processing flowchart of the information processing system of one embodiment of the present invention. In the processing flowchart shown in FIG. 4, prompts including first to n-th instruction sentences are sequentially transmitted, so that n information tables are filled (n is an integer of 2 or more).

### Processing Flowchart 2

At the start of the flowchart, x=1. First, as in the flowchart of FIG. 2, voice data is obtained (Step S11), and then, text data based on the voice data is created (Step S12).

Next, a processing unit creates an x-th prompt including text data and an instruction sentence and transmits the x-th prompt to an information collecting unit (Step S21).

The information collecting unit generates an x-th information table and a question to the user on the basis of the received x-th prompt (Step S22) and transmits them to the processing unit. In the case where the user's discussion content is sufficient and no missing information is found in the information table, the information collecting unit does not generate a question in some cases.

On the basis of the x-th information table and the question to the user received from the information collecting unit, the processing unit determines whether the x-th information table is filled with necessary information (Step S23).

When determining that the x-th information table is not filled with necessary information in Step S23, the processing unit displays the information table and the question to the user on a display unit as information related to the voice data of the user (Step S24), and then the procedure returns to Step S11.

When determining that the x-th information table is filled with necessary information in Step S23, the processing unit determines whether x=n (Step S25). When x=n is not satisfied (that is, x<n) in Step S25, 1 is added to x (Step S26), and the procedure returns to Step S11. The procedure may return to Step S11 after the x-th information table is displayed on the display unit as information related to the voice data of the user.

When x=n is satisfied in Step S25, the processing unit converts the first to n-th information tables into display formats that are easily read by the user and then displays the information tables on the display unit as information related to the voice data of the user (Step S27).

Through the above processing flowchart, the information processing system of one embodiment of the present invention can give aid to the user's discussion, so that the n information tables can be filled. In the processing flowchart shown in FIG. 4, a certain information table is filled with necessary information by the sufficient user's discussion before the next information table is filled, which allows an adequate question to be displayed in accordance with the progress of the user's discussion and the discussion to proceed smoothly.

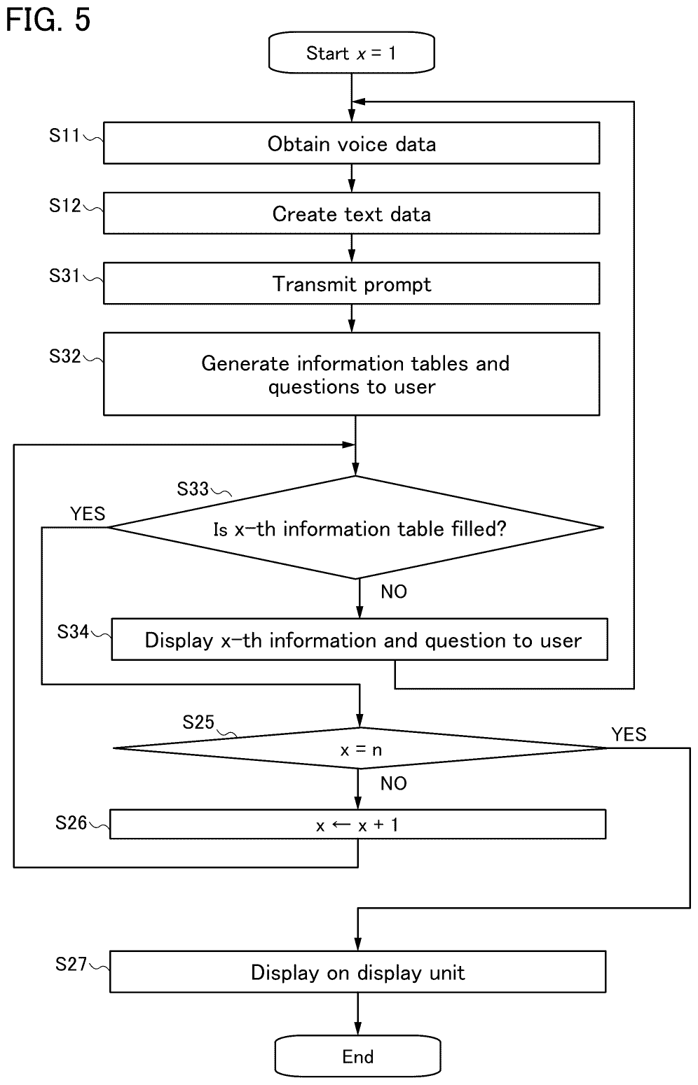

FIG. 5 shows another example of the processing flowchart of the information processing system of one embodiment of the present invention. In the processing flowchart shown in FIG. 5, in the case where a prompt includes instruction sentences to generate all of first to n-th information tables and questions to the user, not all of the first to n-th information tables and the questions to the user are displayed on the display portion but some of the first to n-th information tables and the questions to the user can be sequentially displayed as appropriate in accordance with the progress of the user's discussion.

### Processing Flowchart 3

At the start of the flowchart, x=1. First, as in the flowcharts of FIG. 2 and FIG. 4, voice data is obtained (Step S11), and then, text data based on the voice data is created (Step S12).

Next, a processing unit creates a prompt including text data and instruction sentences and transmits the prompt to an information collecting unit (Step S31). Note that here, the instruction sentences include instructions to generate first to n-th information tables and questions to the user.

Then, the information collecting unit generates information tables and questions to the user on the basis of the received prompt (Step S32) and transmits them to the processing unit. In the case where the user's discussion content is sufficient and no missing information is found in the information tables, the information collecting unit does not generate questions in some cases.

On the basis of the first to n-th information tables and the questions to the user received from the information collecting unit, the processing unit determines whether the x-th information table is filled with necessary information (Step S33).

When determining that the x-th information table is not filled with necessary information in Step S33, the processing unit displays the x-th information and a question to the user on a display unit (Step S34), and the procedure returns to Step S11.

When determining that the x-th information table is filled with necessary information in Step S33, whether x=n is determined (Step S25). When x=n is not satisfied (that is, x<n) in Step S25, 1 is added to x (Step S26), and the procedure returns to Step S33. Although not shown in FIG. 5, when it is determined that the x-th information table is filled with necessary information in Step S33, the x-th information table may be displayed on the display unit.

When x=n is satisfied in Step S25, the processing unit converts the first to n-th information tables into display formats that are easily read by the user and then displays the information tables on the display unit (Step S27).

Through the above processing flowchart, the information processing system of one embodiment of the present invention can give aid to the user's discussion, so that the n information tables can be filled. In the processing flowchart shown in FIG. 5, even with one type of instruction sentence included in the prompt, after a certain information table is filled with necessary information by the sufficient user's discussion, a question to fill the next information table can be displayed, which allows an adequate question to be displayed in accordance with the progress of the user's discussion and the discussion to proceed smoothly.

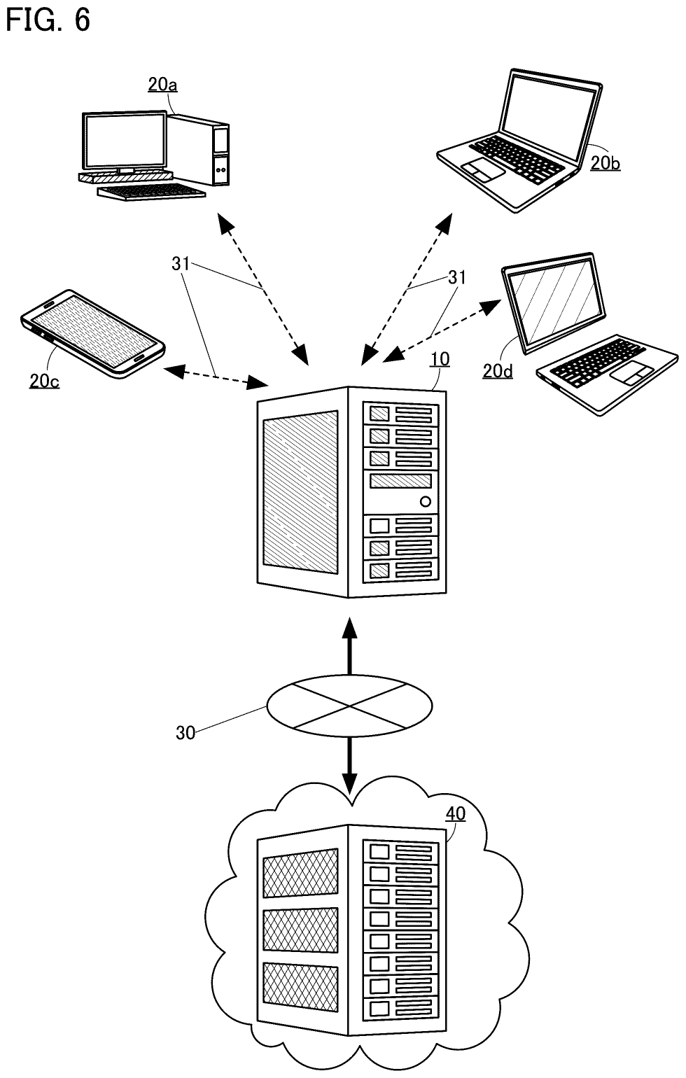

FIG. 6 shows an example of a network configuration diagram for executing the above flowchart.

As examples of the input/output interface, FIG. 6 shows an information terminal 20a, an information terminal 20b, an information terminal 20c, and an information terminal 20d. The information terminals 20a, 20b, 20c, and 20d are capable of communicating data with the information processing device 10 via a network 31. The information processing device 10 is capable of communicating data with the information processing device 40 via a network 30.

A global network or a local network can be used as each of the networks 30 and 31. As the global network, the Internet, which is an infrastructure of the World Wide Web (WWW), can be used. As the local network, an intranet or an extranet can be used. For example, the Internet can be used for both the network 30 and the network 31. Alternatively, an intranet or an extranet can be used for both the network 30 and the network 31. A smaller computer network than the network 30 may be used as the network 31. For example, the network 30 may be a global network (e.g., the Internet), and the network 31 may be a local network (e.g., an intranet).

Alternatively, as each of the networks 30 and 31, a computer network such as a personal area network (PAN), a local area network (LAN), a campus area network (CAN), a metropolitan area network (MAN), a wide area network (WAN), or a global area network (GAN) can be used.

In the case where wireless communication is performed, it is possible to use, as a communication protocol or a communication technology, a communication standard such as the fourth-generation mobile communication system (4G), the fifth-generation mobile communication system (5G), or the sixth-generation mobile communication system (6G), or a communication standard developed by IEEE such as Wi-Fi (registered trademark) or Bluetooth (registered trademark).

The user of the information processing system can access the information processing device 10 via the network 31 from the information terminals 20a to 20d or the like. Then, the user can receive service using the information processing system of one embodiment of the present invention.

The user can utilize the information processing device 10 with use of the dedicated software or application installed on the information terminal 20a, for example. The user can also utilize the information processing device 10 with use of the information terminal 20a via the network 31 or on the web browser, for example.

For example, in the case where a plurality of users make discussion using the information processing system of one embodiment of the present invention, the users may use the same information terminal or the respective information terminals. When the users use the respective information terminals, the information processing system of one embodiment of the present invention can be used to give aid to the discussion by the users apart from each other.

An organization such as a company that provides a service (hereinafter also referred to as a service provider) using the information processing system of one embodiment of the present invention can provide a service with the use of the information processing device 10. The information processing device 10 is a device capable of executing processing using the information processing system of one embodiment of the present invention. FIG. 6 shows a server computer as an example.

The information processing device 10 creates a prompt on the basis of an original text (first text data) input to an input/output interface. The information processing device 10 is a computer with higher processing capability than the information terminal 20a. In this embodiment, the information processing device 10 functions as a processing unit. This step corresponds to Step S12 in FIG. 2.

A plurality of prompts created by the information processing device 10 are input as data to the information processing device 40 via the network 30. The information processing device 40 can perform information processing such as arithmetic processing with use of the data transmitted from the information processing device 10.

The information processing device 40 is a large computer such as a server computer or a supercomputer. The information processing device 40 is a computer with higher processing capability than the information terminal 20a. The information processing device 40 is a computer with higher processing capability than the information processing device 10. The information processing device 40 preferably has a function of a parallel computer. When the information processing device 40 is used as a parallel computer, large-scale computation necessary for AI learning and inference can be performed, for example. In the case where both the information processing device 10 and the information processing device 40 have a function of a parallel computer, the information processing device 40 has high processing capacity and can perform large-scale computation as compared with the information processing device 10.

The information processing device 40 can perform processing using a natural language processing model using AI. It is possible to execute processing using, for example, a natural language processing model using AI such as Bidirectional Encoder Representations from Transformers (BERT), Text-to-Text Transfer Transformer (T5), GPT-3, GPT-3.5, GPT-4 (registered trademark), Language Model for Dialogue Applications (LaMDA), Pathways

Language Model (PaLM), or Llama2.

In this embodiment, the information processing device 40 can utilize an AI text correction tool, e.g., GPT-4 (registered trademark). The service provider can utilize the information processing device 40 via the network 30 without need to prepare the information processing device 40 on his or her own.

The information processing device 40 is capable of transmitting the result of the information processing to the information processing device 10 via the network 30.

Inputting data to the information processing device 40 is referred to as prompt transmission. In this specification, transmission of a prompt to the information processing device 40 means the same as transmission of a prompt to an information collecting unit.

This embodiment shows an example in which the information processing system of one embodiment of the present invention is used to give aid to the user's discussion and assist the user in creating a trouble report; however, the application of the information processing system of one embodiment of the present invention is not limited to the assistance for the creation of a trouble report. For example, with prompts changed for the respective documents, the information processing system of one embodiment of the present invention can be used to give aid to creation of a variety of documents with predetermined input items such as a planning document, a contract, a specification, a product manual, and a research report.

This application is based on Japanese Patent Application Serial No. 2024-003235 filed with Japan Patent Office on Jan. 12, 2024, the entire contents of which are hereby incorporated by reference.

What is claimed is:

1. An information processing system comprising:
an input/output interface that obtains voice data of a user and displays information related to the voice data of the user;
a processing unit that creates text data based on the voice data of the user and creates a prompt comprising the text data; and
an information collecting unit that collects information based on the prompt and generates an information table and a question to the user,
wherein the input/output interface is configured to output the voice data to the processing unit,
wherein the processing unit is configured to transmit the prompt to the information collecting unit,
wherein the information collecting unit is configured to transmit the information table and the question to the user to the processing unit, and
wherein the processing unit is configured to create information related to the voice data of the user based on the information table and the question to the user and output the information to the input/output interface.

2. The information processing system according to claim 1,
wherein the processing unit is configured to convert a display format of the information table, and
wherein the information related to the voice data of the user comprises at least any one of the information table, the question to the user, and the information table with the converted display format.

3. The information processing system according to claim 1,
wherein the information collecting unit collects information about a trouble.

4. The information processing system according to claim 3,
wherein the processing unit is configured to convert the information table into a fishbone diagram, and
wherein the information related to the voice data of the user comprises at least any one of the information table, the question to the user, and the fishbone diagram.
